(19) United States
(12) Patent Application Publication
(10) Pub. No.: US 2014/0297790 A1
(43) Pub. Date: Oct. 2, 2014

(54) SERVER, TERMINAL APPARATUS, SERVICE TRANSIT SERVER, AND CONTROL METHOD THEREOF

(71) Applicant: Samsung Electronics Co., Ltd., Suwon-si (KR)

(72) Inventors: In-jee SONG, Seoul (KR); Ji-hye CHUNG, Seoul (KR); Bo-ra LEE, Seoul (KR); Hye-jeong LEE, Seoul (KR)

(73) Assignee: Samsung Electronics Co., Ltd., Suwon-si (KR)

(21) Appl. No.: 14/187,920

(22) Filed: Feb. 24, 2014

(30) Foreign Application Priority Data
Mar. 26, 2013 (KR) 10-2013-0032319

(51) Int. Cl. H04L 29/08

(52) U.S. Cl. CPC H04L 67/16
USPC 709/217

(57) ABSTRACT

A server, a terminal apparatus, a service transit server, and a control method thereof are provided. The server includes a communicator configured to communicate with a terminal apparatus, a storage configured to store information regarding contexts collectable from the terminal apparatus, a determinator configured to, in response to an occurrence of an event to change a service provided by the server, determine whether contexts regarding the changed service are collectable from the terminal apparatus based on the information regarding contexts and a controller configured to, in response to the determinator determining that the contexts regarding the changed service are collectable, request the terminal apparatus to transmit the contexts regarding the changed service and provide the changed service based on the contexts received in response to the request.

### CROSS-REFERENCE TO RELATED APPLICATIONS

This application claims priority from Korean Patent Application No. 10-2013-0032319, filed in the Korean Intellectual Property Office on Mar. 26, 2013, the disclosure of which is incorporated herein by reference, in its entirety.

### BACKGROUND

1. Field

Apparatuses and methods consistent with exemplary embodiments relate to a server, a terminal apparatus, a service transit server, and control methods thereof, and more particularly, to a server to provide an extended service to a terminal apparatus, a terminal apparatus, a service transit server, and control methods thereof.

2. Description of the Related Art

In general, a server which provides various application services provide services to a corresponding terminal apparatus based on collectable context from terminal apparatuses such as a smart phone, a smart television, and so on. For example, a server may provide a television guide service, and a terminal apparatus may collect context regarding information related to viewing history, which shows what broadcast programs a user has watched. In this case, the server may receive the context regarding the information related to viewing history from the terminal apparatus, and provide a television guide service to the corresponding terminal apparatus, based on the context regarding the received information related to viewing history.

In other words, the terminal apparatus of the related art may provide only the contexts regarding the service which has been provided before extension of a server based on a predetermined agreement to the corresponding server. Accordingly, even in response to the server providing an extended service such as an application recommendation service, the contexts regarding the extended service cannot be provided from the terminal apparatus, so the extended service cannot be provided to the corresponding terminal apparatus.

In this regard, in order for a terminal apparatus to be provided with an extended service, the terminal apparatus should have additional function to collect contexts regarding the extended service, which causes inconvenience to users.

### SUMMARY

One or more exemplary embodiments relates to the feature that, when a server which has provide a service based on context collected from a terminal apparatus provides an extended service, the corresponding terminal apparatus dynamically changes contexts regarding the extended service and provides the same to the server.

According to an aspect of an exemplary embodiment, there is provided a server including a communicator configured to communicate with a terminal apparatus, a storage configured to store information regarding contexts collectable from the terminal apparatus, a determinator configured to, in response to an occurrence of an event to change a service provided by the server, determine whether contexts regarding the changed service are collectable from the terminal apparatus based on the information regarding contexts, and a controller configured to, in response to the determinator determining that the contexts regarding the changed service are collectable, request the terminal apparatus to transmit the contexts regarding the changed service and provides the changed service based on the contexts received in response to the request.

In response to an occurrence of an event to add a second service while a first service is provided based on first contexts received from the terminal apparatus, the determinator may determine whether contexts regarding the added second service are collectable, and in response to the determinator determining that contexts regarding the added second service are collectable, the controller may request the terminal apparatus to transmit second contexts regarding the added second service, and provide the added second service based on the second contexts received in response to the request.

In response to an occurrence of an event to change to a third service while the first service is provided based on the first contexts received from the terminal apparatus, the determinator may determine whether contexts regarding the changed third service are collectable, and in response to the determinator determining that the contexts regarding the changed third service are collectable, the controller may request the terminal apparatus to transmit third contexts regarding the changed third service, and provide the changed third service based on the third contexts received in response to the request.

In response to the determinator determining that contexts regarding the changed service are not collectable, the controller may provide the changed service based on at least one of predetermined conditions and collected contexts from other terminal apparatuses.

The contexts may include at least one of channel information of a program which is currently being watched, information related to viewing history, application information, location information of the terminal apparatus, and user information.

The terminal apparatus may be at least one of a user terminal apparatus and a content providing server which is interlocked with the user terminal apparatus.

According to an aspect of another exemplary embodiment, there is provided a terminal apparatus including an output unit, a communicator configured to transmit information regarding contexts collectable from the terminal apparatus to a server and receives a command to transmit contexts regarding the changed service from the server according to an event to change a service provided by the server, and a controller configured to transmit to the server collected contexts in response to the received transmission command, and controls the output unit to output results corresponding to a service provided by the server based on the transmitted contexts.

In response to a command to transmit second contexts regarding the second service being received from the server while the output unit outputs results corresponding to a first service based on pre-collected first contexts, the controller may collect the second contexts and transmit the collected second contexts to the server according to the received transmission command.

The contexts may include at least one of channel information of a program which is currently watched, information related to viewing history, application information, location information of the terminal apparatus and user information.

According to an aspect of another exemplary embodiment, there is provided a service transit apparatus including a communicator configured to perform communication with a terminal apparatus, a storage configured to store information regarding contexts collectable from the terminal apparatus, a determinator configured to, in response to an occurrence of an event to change a service provided by a service providing server, determine whether contexts regarding the changed service are collectable form the terminal apparatus based on information regarding the contexts, rand a controller configured to, in response to the determinator determining that contexts regarding the changed service are collectable, control to request the terminal apparatus to transmit contexts regarding the changed service and transmit to the service providing server contexts received in response to the request.

According to an aspect of another exemplary embodiment, there is provided a method of controlling a server, the method including storing information regarding contexts collectable from a terminal apparatus, in response to an occurrence of an event to change a service provided by the server, determining whether contexts regarding the changed service are collectable from the terminal apparatus based on information regarding the contexts, and in response to determining that contexts regarding the changed service are collectable, requesting the terminal apparatus to transmit contexts regarding the changed service, and providing the changed service to the terminal apparatus based on contexts received from the terminal apparatus in response to the request.

The determining may include, in response to an occurrence of an event to add a second service, determining whether contexts regarding the added second service are collectable while a first service is provided based on first contexts received from the terminal apparatus, and the providing the changed service may include, in response to determining that contexts regarding the added second service are collectable, requesting the terminal apparatus to transmit second contexts regarding the added second service, and providing the added second service based on second contexts received in response to the request.

The determining may include, in response to an occurrence of an event to change a service to a third service while a first service is provided based on first contexts received from the terminal apparatus, determining whether contexts regarding the changed third service are collectable, and the providing the changed service may include, in response to determining that contexts regarding the changed third service are collectable, requesting the terminal apparatus to transmit third contexts regarding the changed third service, and providing the changed third service based on third contexts received in response to the request.

The providing the changed service may include, in response to determining that contexts regarding the changed service are not collectable, providing the changed service based on at least one of predetermined conditions and collected contexts from other terminal apparatuses.

The contexts may include at least one of channel information of a program which is currently being watched, information related to viewing history, application information, location information of the terminal apparatus and user information.

The terminal apparatus may be at least one of a user terminal apparatus and a content providing server which is interlocked with the user terminal apparatus.

According to an aspect of another exemplary embodiment, there is provided a method of controlling a terminal apparatus, the method including transmitting information regarding contexts collectable from the terminal apparatus to a server, receiving a command to transmit contexts regarding the changed service from the server according to an event to change a service provided by the server, collecting contexts corresponding to the received transmission command and transmitting the collected contexts to the server, and outputting results corresponding to a service provided by the server based on the transmitted contexts.

The method may further include, after transmitting the information regarding collectable contexts to the server, outputting results corresponding to a first service provided by the server based on pre-collected first contexts, and the transmitting collected contexts to the server may include, in response to a command to transmit second contexts regarding the second service being received from the server, collecting the second contexts and transmitting the collected second contexts to the server, according to the received transmission command.

The contexts may include at least one of channel information of a program which is currently being watched, information related to viewing history, application information, location information of the terminal apparatus and user information.

According to an aspect of another exemplary embodiment, there is provided a server including a determinator configured to determine whether contexts regarding a changed service are collectable from a terminal apparatus based on received information regarding contexts; and a controller configured to request the terminal apparatus transmit contexts regarding the changed service and provide the changed service based on contexts received in response to the request, in response to a determination that contexts regarding the changed service are collectable.

### BRIEF DESCRIPTION OF THE DRAWINGS

The above and/or other aspects will be more apparent by describing certain exemplary embodiments with reference to the accompanying drawings, in which:

FIG. 1 is a first system view which provides a service based on collected context according to an exemplary embodiment;

FIG. 2 is a second system view providing a service based on collected context according to another exemplary embodiment;

FIG. 3 is a block diagram of a server according to an exemplary embodiment;

FIG. 4 is a block diagram of a terminal apparatus according to an exemplary embodiment;

FIG. 5 is a flowchart which illustrates a method of providing an extended service to a terminal apparatus from a server according to an exemplary embodiment; and

FIG. 6 is a flowchart which illustrates a method of providing contexts regarding an extended service to a server from a terminal apparatus according to an exemplary embodiment.

### DETAILED DESCRIPTION OF THE EXEMPLARY EMBODIMENTS

It should be observed the method steps and system components have been represented by conventional symbols in the figure, showing only specific details which are relevant for an understanding of the present disclosure. Further, details which may be readily apparent to person ordinarily skilled in the art may not have been disclosed. In the exemplary embodiments, relational terms such as first and second, and the like, may be used to distinguish one entity from another entity, without necessarily implying any actual relationship or order between such entities.

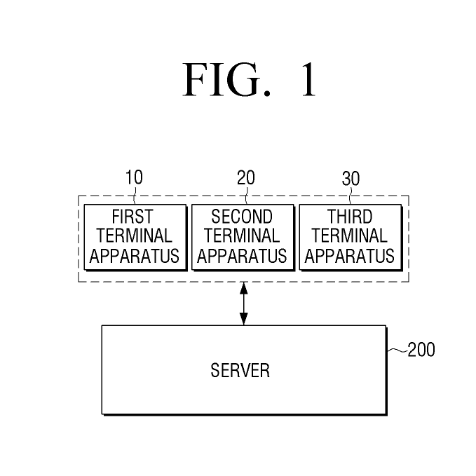

FIG. 1 is a first system view providing a service based on collected context according to an exemplary embodiment.

As illustrated in FIG. 1, a system according to an exemplary embodiment comprises a plurality of terminal apparatuses 10˜30 (hereinafter, referred to as first to third terminal apparatuses), and a server 200. The first to third terminal apparatuses 10˜30 may be a user terminal apparatus such as a smart phone, a smart television, and so on, but are not limited thereto. At least one of the first to the third terminal apparatuses 10˜30 may be a content providing server which provides a content in association with the remaining terminal apparatuses. In an exemplary embodiment, the first to third terminal apparatuses 10˜30 will be limited to a user terminal apparatus such as a smart phone, a smart television, and so on. The server 200 may be a server which provides the first to third terminal apparatuses 10˜30 with services such as a television guide service, movie search service, an application recommendation service, and so on.

Specifically, in response to communication between the first to third terminal apparatuses 10˜30 with the server 200 being initiated for the first time, information regarding contexts, which can be collected by the first to the third terminal apparatuses 10˜30, are transmitted to the server 200. Herein, the information regarding contexts may be metadata which defines contexts collectable in association with services provided by the server 200. The metadata may be defined as a schema such as XMI or RDF. Depending on an exemplary embodiment, the first terminal apparatus 10 may collect contexts regarding at least one of information regarding a channel of a broadcast program which a user is currently watching, information related to viewing history regarding a broadcast program which has been watched by a user, information regarding an application installed in the first terminal apparatus 10 or information regarding execution history of an installed application, location information of the first terminal apparatus 10, and user information. In this case, the first terminal apparatus 10 may transmit information regarding each of the collectable contexts to the server 200. In this case, the first terminal apparatus 10 may transmit to server 200 identification information related to the first terminal apparatus 10 along with the information regarding contexts.

As such, when information regarding collectable contexts is received from the first to third terminal apparatuses 10˜30, the server 200 may store information regarding the contexts received from the first to third terminal apparatuses 10˜30. Accordingly, while information regarding the contexts of each of the first to third terminal apparatuses 10˜30 is stored, the server 200 may provide a first service to the first to third terminal apparatuses 10˜30. In this case, the server 200 determines whether it is possible to collect contexts regarding the first service in the first to third terminal apparatuses 10˜30 with reference to the information regarding the contexts of the first to third terminal apparatuses 10˜30. In response to a determination that the contexts regarding the first service are collectable in the first to third terminal apparatuses 10˜30, the server 200 requests the first to third terminal apparatuses 10˜30 transmit the contexts regarding the first service. Accordingly, the first to third terminal apparatuses 10˜30 collect the contexts regarding the first service and transmit the collected contexts to the server 200. In response to the collected contexts regarding the first service being received from the first to third terminal apparatuses 10˜30, the server 200 may provide the first service based on the contexts received from the first to third terminal apparatuses 10˜30.

For example, the server 200 may provide a television guide service, and the first to the third terminal apparatuses 10˜30 may collect contexts regarding information related to viewing history. In this case, the server 200 may store information regarding the corresponding contexts of the first to third terminal apparatuses 10˜30. Accordingly, the server 200 makes a determination that it is possible to collect contexts regarding a television guide service in the first to third terminal apparatuses 10˜30, with reference to information regarding pre-stored contexts, and requests the first to third terminal apparatuses 10˜30 transmit contexts regarding information related to viewing history. In response to the request, the first to third terminal apparatuses 10˜30 collect contexts regarding information related to viewing history of broadcast programs which a user has watched and may transmit the collected contexts to the server 200. Accordingly, the server 200 may provide the first to third terminal apparatuses 10˜30 with a television guide service which is most suitable for users in each of the first to third terminal apparatuses 10˜30, based on the contexts received from the first to third terminal apparatuses 10˜30.

For example, in response to a determination that a user frequently watches instructional programs based on contexts collected from the first terminal apparatus 10, the server 200 may provide the first terminal apparatus 10 with a television guide service regarding instructional programs. In addition, in response to a determination that a user watches entertainment programs frequently based on contexts received from the second terminal apparatus 20, the server 200 may provide the second terminal apparatus 20 with a television guide service regarding entertainment programs. Further, in response to a determination that a user frequently watches sports programs based on contexts received from the third terminal apparatus 30, the server 200 may provide the third terminal apparatus 30 with a television guide service regarding sports programs. Accordingly, as the first to third terminal apparatuses 10˜30 output results regarding a television guide service provided from the server 200, a user may be provided with a television guide service regarding broadcast programs that the user frequently watches.

An event to add a second service may occur while the server 200 provides the first to third terminal apparatuses 10˜30 with the first service based on the contexts received from the first to third terminal apparatuses 10˜30. In this case, the server 200 determines whether there is a terminal apparatus which can collect contexts regarding the second service based on pre-stored information regarding contexts related to the first to third terminal apparatuses 10˜30. For example, the server 200 may provide an application recommendation service along with the television guide service. In this case, the server 200 may determine whether there is a terminal apparatus which can collect contexts regarding the application recommendation service based on pre-stored information regarding contexts of the first to third terminal apparatuses 10˜30. For example, suppose that the first terminal apparatus 10 from among the first to third terminal apparatuses 10˜30 may collect information regarding applications. In this case, the server 200 may store information related to contexts regarding collecting of information on applications received from the first terminal apparatus 10. Accordingly, the server 200 determines that the first terminal apparatus 10 from among the first to third terminal apparatuses 10˜30 may collect contexts regarding the application recommendation service, based on the pre-stored information regarding contexts, and requests the first terminal apparatus 10 in order to transmit contexts regarding application information. In response to the request, the first terminal apparatus 10 collect contexts regarding application information according to execution of applications of a user and may transmit the contexts to the server 200. Accordingly, the server 200 may provide the first terminal apparatus 10 with an application recommendation service which is most suitable for the user of the first terminal apparatus 10, based on the contexts received from the first terminal apparatus 10.

As such, the system according to an exemplary embodiment, in response to a service provided by the server 200 being extended, may request the first to third terminal apparatuses 10˜30 collect contexts regarding the extended service, and provide the extended service based on the contexts which are received from the first to third terminal apparatuses 10˜30, in response to the request.

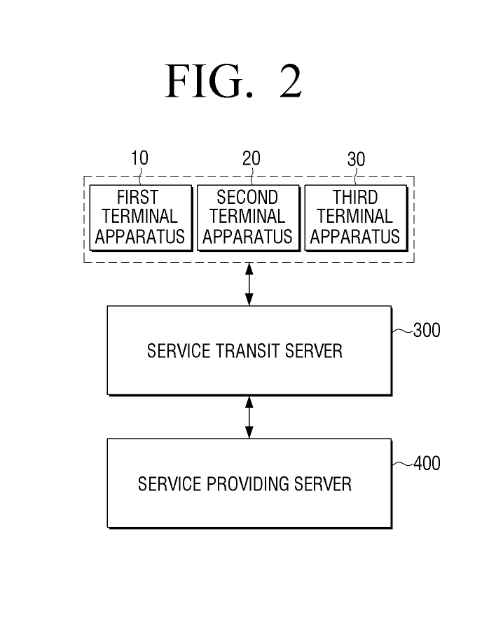

FIG. 2 is a second system view providing a service based on collected context, according to another exemplary embodiment.

As illustrated in FIG. 2, a system according to an exemplary embodiment comprises the first to third terminal apparatuses 10˜30, a service transit apparatus 300, and a service providing server 400. Herein, the first to third terminal apparatuses 10˜30 may be a user terminal apparatus such as a smart phone, a smart television, and so on, but is not limited thereto. At least one of the first to third terminal apparatuses 10˜30 may be a content providing server which provides contents in association with the remaining terminal apparatuses.

The service transit apparatus 300 is a transit apparatus which receives contexts collected from the first to third terminal apparatuses 10˜30, transmits the contexts to the service providing server 400, and transmits a service provided by the service providing server to the first to third terminal apparatuses 10˜30. In addition, the service providing server 400 may be a server which provides the first to third terminal apparatuses 10˜30 with services such as a television guide service, movie search service, an application recommendation service, and so on, based on the contexts received from the service transit apparatus 300.

Specifically, in response to communication between the first to third terminal apparatuses 10˜30 with the service transit apparatus 300 being initiated for the first time, information regarding contexts which can be collected by the first to third terminal apparatuses 10˜30 are transmitted to the service transit apparatus 300. Accordingly, the service transit apparatus 300 stores information regarding contexts received from the first to third terminal apparatuses 10˜30. Subsequently, the service transit apparatus 300 determines whether it is possible to collect contexts regarding the first service, which is currently provided by the service providing server 400 with reference to information regarding pre-stored contexts. In response to a determination that the first to third terminal apparatus 10˜30 may collect contexts regarding the first service, the service transit apparatus 300 requests the first to third terminal apparatuses 10˜30 transmit the contexts regarding the first service. Accordingly, the first to third terminal apparatus 10˜30 collect contexts regarding the first service, and transmit the collected contexts to the service transit apparatus 300. In response to the contexts regarding the first service being received from the first to third terminal apparatus 10˜30, the service transit apparatus 300 transmits the contexts received from the first to third terminal apparatus 10˜30 to the service providing server 400. Accordingly, the service providing server 400 receives the contexts collected from the first to third terminal apparatus 10˜30 through the service transit apparatus 300, and provides the first service based on received contexts of each of the first to third terminal apparatus 10˜30. Thus, the first to third terminal apparatus 10˜30 may receive the first service provided by the service providing server 400 through the service transit apparatus 300, and may output results which correspond to the first service.

An event to further provide the second service while the service providing server 400 provides the first service to the first to third terminal apparatus 10˜30 may occur. When such an event occurs, the service transit apparatus 300 determines whether there is a terminal apparatus which can collect contexts regarding the second service based on pre-stored information regarding contexts of the first to the third terminal apparatuses 10˜30. In response to a determination that the first terminal apparatus 10 from among the first to third terminal apparatuses 10˜30 may collect contexts regarding the second service, the service transit apparatus 300 requests first terminal apparatus 10 transmit contexts regarding the second service. In response to the request, the first terminal apparatus 10 collects contexts regarding the second service and transmits the collected contexts to the service transit apparatus 300, and the service transit apparatus 300 transmits the contexts received from the first terminal apparatus 10 to the service providing server 400. Accordingly, the service providing server 400 provides the second service based on the contexts of the first terminal apparatus 10 which are received through the service transit apparatus 300. Accordingly, the first terminal apparatus 10 may receive the second service provided by the service providing server 400 through the service transit apparatus 300, and output results while corresponding to the second service.

In the above description, a system which provides a service based on collected contexts according to an exemplary embodiment has been schematically explained. Hereinafter, each configuration of the terminal apparatus 100 and the server 200 will be explained in detail. Herein, the terminal apparatus 100 may be one of the above-described first to third terminal apparatuses 10˜30.

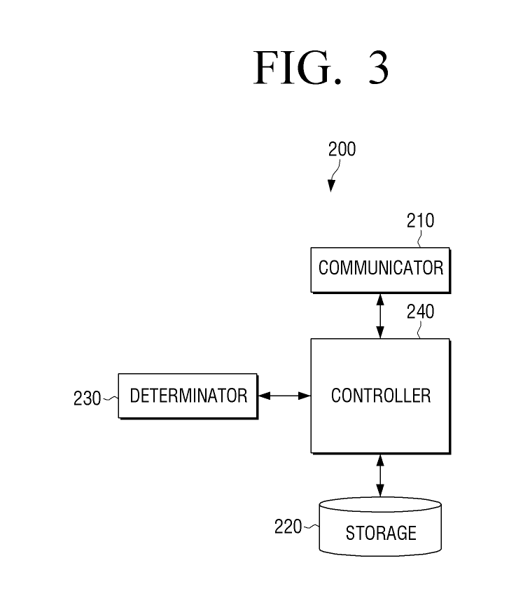

FIG. 3 is a block diagram of a server, according to an exemplary embodiment.

As illustrated in FIG. 3, the server 200 comprises a communicator 210, a storage 220, a determinator 230, and a controller 240. The communicator 210 performs communication with the terminal apparatus 100. In particular, when communication with the terminal apparatus 100 is initiated for the first time, the communicator 210 may receive information regarding contexts collectable from the terminal apparatus 100. Herein, the information regarding contexts is metadata which defines contexts collectable from the terminal apparatus 100, in association with the service provided by the server 200, and may be defined as a schema such as XMI or RDF. Depending on an exemplary embodiment, the terminal apparatus 100 may collect contexts regarding at least one of information regarding a channel of broadcast program which a user is currently watching information related to viewing history regarding a broadcast program which has been watched by a user, information regarding an application installed in the terminal apparatus 100 or information regarding execution history of an installed application, location information of the terminal apparatus 100 and user information.

Each of the contexts is set by manufacturers, and when communication with the server 200 is initiated for the first time, the terminal apparatus 100 transmits information regarding each of the collectable contexts to the server 200. Accordingly, the communicator 210 may receive information regarding collectable contexts from the terminal apparatus 100. The communicator 210 may receive information regarding collectable contexts from the terminal apparatus 100 through a wired or wireless communication module (not shown).

The storage 220 is a storage medium where various programs necessary to operate the server 200 are stored, and may be implemented as a memory, a Hard Disk Drive (HDD), and so on. For example, the storage 220 may comprise a ROM for storing programs to perform operations of the controller 240 which will be explained later, a ROM for temporarily storing data regarding operations of the controller 240, and so on. In addition, the storage 220 may further comprise Electrically Erasable and Programmable ROM (EEROM) for storing various reference data. In particular, the storage 220 may store information regarding contexts received from the terminal apparatus 100 through the communicator 210.

In response to the occurrence of an event which changes a service provided by the server 200, the determinator 230 determines whether it is possible to collect contexts regarding the changed service from the terminal apparatus 100 based on information regarding contexts stored in the storage 220. If it is determined that it is possible to collect contexts regarding the changed service from the terminal apparatus 100, the controller 240 requests the terminal apparatus 100 transmit contexts regarding the changed service. Subsequently, when the collected contexts regarding the changed service are received from the terminal apparatus 100 through the communicator 210, the changed service is provided to the terminal apparatus 100 based on the received contexts.

The controller 240 may provide the first service to the terminal apparatus 100 based on first contexts received from the terminal apparatus 100. As such, when an event to add the second service while the first service is provided occurs, the determinator 230 determines whether it is possible to collect contexts regarding the second service from the terminal apparatus 100 based on information regarding contexts stored in the storage 220. If it is determined that it is possible to collect contexts regarding the second service, the controller 240 requests the terminal apparatus 100 to transmit second contexts regarding the second service. Accordingly, the terminal apparatus 100 collects the first contexts regarding the first service and the second contexts regarding the second service and transmits the collected contexts to the server 200. Accordingly, the controller 240 may not only provide the first service to the terminal apparatus 100 based on the first contexts received from the terminal apparatus 100 but may also provide the added second service to the terminal apparatus 100 based on the received second contexts.

For example, the server 200 may only provide a television guide service from among various services. Herein, the television guide service may be the first service. In this case, the determinator 230 determines whether it is possible to collect contexts regarding the television guide service from the terminal apparatus 100 based on information regarding contexts stored in the storage 220. If it is determined that it is possible to collect contexts regarding the television guide service, the controller 240 requests the terminal apparatus 100 transmit contexts regarding information related to viewing history. In response to the request, the terminal apparatus 100 collects contexts regarding information related to viewing history of broadcast programs that a user has watched and transmits the collected contexts to the server 200. Accordingly, the controller 240 may provide the television guide service based on the contexts received from the terminal apparatus 100.

As such, the server 200 may further provide a content service such as searching weather or recommending a movie while the television guide service, which is the first service being provided. Herein, the content service may be the above-described second service. In response to the occurrence of an event to further provide a content service the determinator 230 determines whether it is possible to collect contexts regarding the content service from the terminal apparatus 100 based on information regarding contexts stored in the storage 220.

For example, the terminal apparatus 100 may collect contexts regarding channel information of a broadcast program which a user is currently watching, information related to viewing history regarding broadcast programs that a user has watched, and a web search. Accordingly, the storage 220 may store information regarding the corresponding contexts, and the determinator 230 determines whether it is possible to use a content service in the terminal apparatus 100 based on information regarding contexts stored in the storage 220. If it is determined that it is possible to use the content service, the controller 240 requests the terminal apparatus 100 transmit contexts regarding the web search, in order to provide the terminal apparatus 100 with the newly-added content service. In response to the request, the terminal apparatus 100 collects contexts regarding web search history information searched from a web server (not shown), in accordance with the user request and transmits to the server 200 the collected contexts along with the contexts regarding information related to viewing history.

As such, when contexts regarding viewing history information and web search history information are received, the controller 240 may provide the television guide service and the newly-added content service to the terminal apparatus 100, based on each of the received contexts. For example, if it is determined that a user frequently watches entertainment programs based on the received contexts regarding information related to viewing history and frequently performs web search regarding weathers based on the received contexts regarding web search history information, the controller 240 may provide the terminal apparatus 100 with a television guide service regarding entertainment programs and a content service regarding weather.

Depending on additional aspects of an exemplary embodiment, an event to change to a third service may occur while the server 200 provides the terminal apparatus 100 with the first service based on the first contexts received from the terminal apparatus 100. As such, when an event to change from the first service to the third service occurs, the determinator 230 determines whether it is possible to collect contexts regarding the third service from the terminal apparatus 100 based on information regarding contexts stored in the storage 220. If it is determined that it is possible to collect contexts regarding the third service, the controller 240 requests that terminal apparatus 100 transmit third contexts regarding the changed third service. Subsequently, when the third contexts regarding the third service are received from the terminal apparatus 100, the controller 240 may provide the terminal apparatus 100 with the changed third service based on the received third contexts.

As described above, the server 200 may only provide a television guide service from among various services. In this case, the determinator 230 determines whether it is possible to collect contexts regarding the television guide service from the terminal apparatus 100 based on information regarding contexts stored in the storage 220. If it is determined that it is possible to collect contexts regarding the television guide service, the controller 240 requests the terminal apparatus 100 transmit contexts regarding the television guide service.

As such, an event to change to the third service, which is an application recommendation service, may occur in the server 200 while the television guide service which is the first service, is being provided. When an event to change to the application recommendation service occurs, the determinator 230 determines whether it is possible to collect contexts regarding the content recommendation service from the terminal apparatus based on information regarding contexts stored in the storage 220.

For example, the terminal apparatus 100 may collect contexts regarding channel information of a broadcast program which a user is currently watching, information related to viewing history regarding applications which are installed in the terminal apparatus 100 or execution history information regarding applications which have been pre-installed. In this case, the storage 220 may store information regarding corresponding contexts, and the determinator 230 determines whether it is possible to use the application recommendation service in the terminal apparatus 100 based on information regarding contexts stored in the storage 220. If it is determined that it is possible to use the application recommendation service, the controller 240 requests the terminal apparatus 100 transmit contexts regarding application information. In response to the request, the terminal apparatus 100 stops collecting contexts regarding information related to viewing history, collects contexts regarding application information, and transmits the collected contexts to the server 200. Accordingly, the controller 240 may provide the terminal apparatus 100 with the application recommendation service, based on the contexts received from the terminal apparatus 100.

If it is determined that it is impossible to collect contexts regarding a service which is added or changed in the terminal apparatus 100, the controller 240 may provide the service added or changed in the terminal apparatus 100 based on at least one of predetermined conditions or contexts collected from another terminal apparatus.

For example, the server 200 may further provide a weather information service, and the terminal apparatus 100 may collect contexts regarding location information of the terminal apparatus 100. In this case, the terminal apparatus 100 transmits contexts regarding location information of the terminal apparatus 100 to the server 200, in response to the request to transmit contexts regarding location information of the terminal apparatus 100. Accordingly, the controller 200 may provide a weather information service including weather information of a region which corresponds to the location of the terminal apparatus 100, based on the contexts received from the terminal apparatus 100. If it is determined that it is impossible to collect contexts regarding location information of the terminal apparatus 100 from the terminal apparatus 100, the controller 200 may provide a weather information service including weather information of a region or a city which is provided to other terminal apparatuses most frequently based on predetermined conditions or weather information of the whole country.

According to an exemplary embodiment, as illustrated in FIG. 2, the server 200 may be implemented as the service transit apparatus 300 and the service providing server 400. In this case, the service providing server 400 is a server which provides services to the terminal apparatus 100, and particularly provides services to the terminal apparatus 100 based on contexts collected from the terminal apparatus 100. The technical features of the service transit apparatus 300 may correspond to those of the communicator 210, the storage 220, the determinator 230, and the controller 240 which are configurations of the server 200 as described in FIG. 3. However, unlike the server 200, the service transit apparatus 300 does not provide a service based on contexts collected from the terminal apparatus 100. The service transit apparatus 300 has been explained in detail with reference to FIG. 2 and thus, further description will not be provided.

Hereinafter, each configuration of the above-described terminal apparatus 100 will be explained in greater detail.

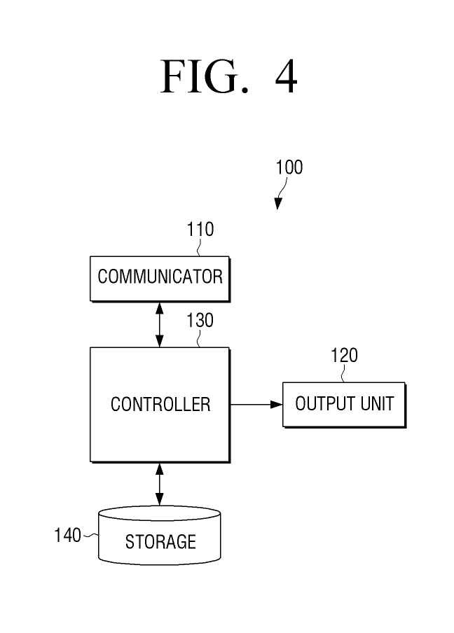

FIG. 4 is a block diagram of a terminal apparatus according to an exemplary embodiment.

As illustrated in FIG. 4, the terminal apparatus 100 comprises a communicator 110, an output unit 120, a controller 130, and a storage 140.

The communicator 110 performs communication with at least one of the server 200 which provides services and a content providing server (not shown) which provides contents. In particular, the communicator 110 performs communication with the server 200 and transmits information regarding contexts collectable from the terminal apparatus 100 to the server 200. Subsequently, the communicator 110 receives from the server 200 a command to transmit contexts regarding a changed service. To do so, the communicator 110 may comprise various communication modules such as a near field communication module (not shown), a wireless communication module (not shown), and so on. Herein, the near field communication module (not shown) is a communication module which performs wireless communication with an external apparatus nearby, and may be Bluetooth, Zigbee, and so on. The wireless communication module (not shown) is a module which is connected to an external network to perform communication according to a wireless communication protocol such as WiFi, IEEE, etc. In addition, the wireless communication module may further comprise a mobile communication module which performs communication by connecting to a mobile communication network according to various mobile communication standards such as 3rd Generation (3G), 3rd Generation Partnership Project (3GPP), Long Term Evolution (LTE), etc. Further, communicator 110 may perform communication with at least one of the server 200 and the content providing server (not shown) by performing communication using a wired LAN method.

The output unit 120 is configured to output at least one of a voice and an image. Specifically, the output unit 120 may output results regarding a service provided from the server 200 or contents received from the content providing server (not shown) in at least one of a voice or an image. To do so, the output unit 120 may comprise an image output unit (not shown) and an audio output unit (not shown).

The controller 130 collects contexts which correspond to a transmission command received from the server 200 through the communicator 110 for a predetermined period of time, and stores the collected contexts in the storage 140. Subsequently, after a predetermined period of time elapses, the controller 130 controls the communicator 110 to transmit to the server 200 the contexts pre-stored in the storage 140. However, this is only an example, and the controller 130 may collect contexts which correspond to a transmission command received from the server 200, and control the communicator 110 to transmit the collected contexts to the server 200, without storing the same. After the collected contexts are transmitted to the server 200, when a service is provided based on the corresponding contexts from the server 200, the controller 130 controls the output unit 120 to output results which correspond to the service in at least one of a voice and an image.

To be specific, in response to a command to transmit the second contexts regarding the second service being received from the server 200 while the output unit 120 is outputting results which correspond to the first service, which is provided based on pre-collected first contexts, the controller 130 collects the second contexts and transmits the collected contexts to the server 200, according to the received transmission command.

Herein, the information regarding the contexts is metadata which defines contexts collectable in the terminal apparatus 100 in association with services provided by the server 200. The metadata may be defined as a schema such as XMI or RDF and stored in the storage 140. Depending on an exemplary embodiment, the contexts collectable in the terminal apparatus 100 may include at least one of information regarding a channel of a broadcast program which a user is currently watching, information related to viewing history regarding a broadcast program which has been watched by a user, information regarding an application installed in the terminal apparatus 100 or information regarding execution history of an installed application, location information of the terminal apparatus 100 and user information.

Specifically, when communication with the server 200 is initiated for the first time, the controller 130 transmits information regarding contexts pre-stored in the storage 140 to the server 200. Subsequently, when a command to transmit the first contexts regarding the first service is received from the server 200, the controller 130 collects the first contexts and transmits the collected contexts to the server 200 according to the received transmission command. For example, the server 200 may only provide the television guide service which is the first service from among various services, and the terminal apparatus 100 may collect contexts as described above. In this case, the server 200 transmits a command to transmit contexts regarding the television guide service to the terminal apparatus 100 with reference to information regarding pre-stored contexts. In response to the transmission command being received, the controller 130 collects contexts regarding information related to viewing history and transmits the collected contexts to the server 200 according to the received transmission command, and the server 200 may provide the television guide service to the terminal apparatus 100 based on the contexts regarding information related to viewing history received from the terminal apparatus 100. Accordingly, the controller 130 may output results which correspond to the television guide service provided by the server 200 through the output unit 120.

The server 200 may further provide the application recommendation service, which is the second service, while providing the television guide service, which is the first service. In this case, the server 200 transmits a command to transmit contexts regarding application information to the terminal apparatus 100 based on information regarding pre-stored contexts. In response to a command to transmit contexts regarding application information being received, the controller 130 collects contexts information regarding application information and transmits the collected contexts to the server 200. In this case, the controller 130 may collect contexts regarding information related to viewing history in order to be continuously provided with the television guide service from the server 200 and transmit the collected contexts to the server 200.

The server 200 may provide a service which is changed to the application recommendation service, the second service, while providing the television guide service, which is the first service. In this case, the controller 130 may stop collecting contexts regarding information related to viewing history, may collect contexts regarding application information, and may transmit the collected contexts to the server 200. Accordingly, the server 200 may provide at least one of the television guide service and the application recommendation service based on the contexts received from the terminal apparatus 100, and the output unit 120 may output results which correspond to a service provided by the server 200 in at least one of a voice and an image according to a control command of the controller 130.

In the above description, each configuration of the terminal apparatus 100 according to an exemplary embodiment has been explained in detail. Hereinafter, a method for controlling the above-described server 200 and the terminal apparatus 100 will be explained in detail.

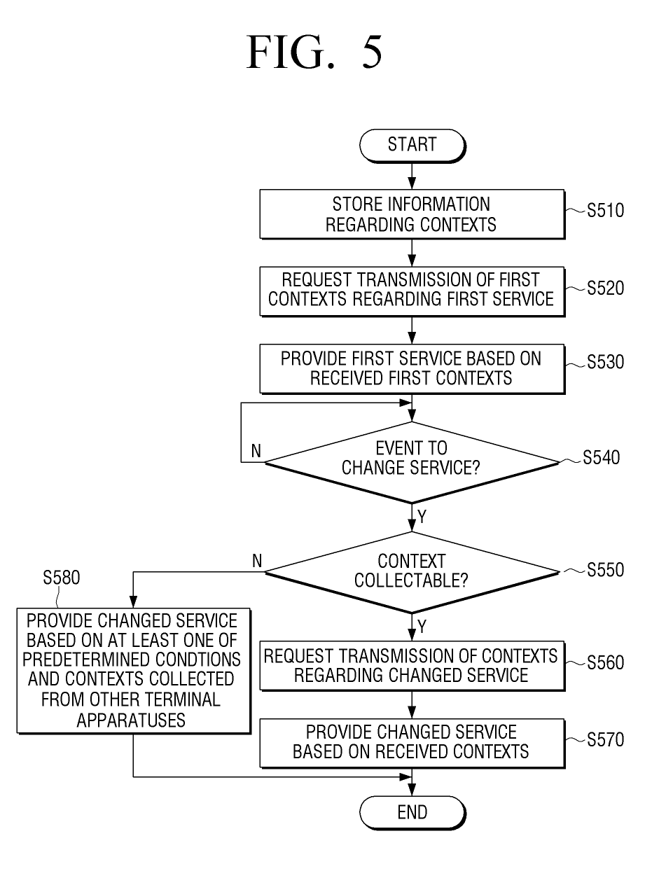

FIG. 5 is a flowchart which illustrates a method of providing an extended service to a terminal apparatus from a server, according to an exemplary embodiment.

As illustrated in FIG. 5, when communication with the terminal apparatus 100 is initiated for the first time, the server 200 receives information regarding contexts collectable from the terminal apparatus 100, and stores the information (S510). Herein, the terminal apparatus 100 may be a user terminal apparatus such as a smart phone, a smart television, etc., or a content providing server which provides contents in association with a user terminal apparatus. The information regarding contexts is metadata which defines contexts collectable from the terminal apparatus 100 in association with the service provided by the server 200, and may be defined as a schema such as XMI or RDF. Depending on an exemplary embodiment, the contexts collectable from the terminal apparatus 100 may include at least one of information regarding a channel of broadcast program which a user is currently watching, information related to viewing history regarding a broadcast program which has been watched by a user, information regarding an application installed in the terminal apparatus 100 or information regarding execution history of an installed application, location information of the terminal apparatus 100, and user information. Accordingly, when communication with the terminal apparatus 100 is initiated for the first time, the server 200 may receive information regarding contexts collectable from the terminal apparatus 100 and may store the information.

The server 200 may provide the first service to the terminal apparatus 100. As such, in order to provide the first service to the terminal apparatus 100, the server 200 requests the terminal apparatus 100 to transmit the first contexts regarding the first service, based on information regarding pre-stored contexts (S520). In response to the request, the terminal apparatus 100 collects the first contexts regarding the first service and transmits the collected first contexts to the server 200. When the first contexts are received, the server 200 provides the first service based on the received first contexts (S530). As such, while the first service is being provided based on the received first contexts, the server 200 determines whether an event has occurred to change the service provided by the server 200, (S540). If it is determined that an event to change the service occurs, the server 200 determines whether it is possible to collect contexts regarding the changed service from the terminal apparatus 100 based on information regarding pre-stored contexts (S550). If it is determined that it is possible to collect contexts regarding the changed service, the server 200 requests the terminal apparatus 100 transmit contexts regarding the changed service (S560). Subsequently, when contexts regarding the changed service are received from the terminal apparatus 100, the server 200 provides the changed service to the terminal apparatus 100 based on the received contexts (S570). If it is determined that it is not possible to collect contexts regarding the changed service in operation S550, the server 200 provides the changed service to the terminal apparatus 100 based on at least one of predetermined conditions and contexts collected from other terminal apparatuses (S580).

In operation S560, the server 200 may provide the changed service to the terminal apparatus 100 based on the following exemplary embodiments. Depending on an exemplary embodiment, the server 200 may further provide the second service while providing the first service. As such, in response to the occurrence of an event to further provide the second service, the server 200 determines whether it is possible to collect the second contexts regarding the second service from the terminal apparatus 100, based on the information regarding pre-stored contexts. If it is determined that it is possible to collect the second contexts regarding the second service, the server 200 requests the terminal apparatus 100 further transmit the second contexts regarding the second service. In response to the request, the terminal apparatus 100 collects the first contexts regarding the first service and the second contexts regarding the second service and transmits the collected first and second contexts to the server 200. Accordingly, the server 200 may provide the first and second services to the terminal apparatus 100 based on the first and second contexts received from the terminal apparatus 100.

In another exemplary embodiment, the server 200 may change the first service which is being provided to a third service and provide the third service. As such, in response to the occurrence of an event to change the service to the third service, the server 200 determines whether it is possible to collect third contexts regarding the third service from the terminal apparatus 100 with reference to information regarding pre-stored contexts. If it is determined that it is possible to collect the third contexts regarding the third service, the server 200 requests the terminal apparatus 100 to transmit the third contexts regarding the third service. In response to the request, the terminal apparatus 100 stops collecting the first contexts regarding the first service, collects the third contexts regarding the third service, and transmits the collected third contexts to the server 200. Accordingly, the server 200 may provide the third service to the terminal apparatus 100 based on the third contexts received from the terminal apparatus 100.

As such, when the service provided by the server 200 is extended, the server 200 according to an exemplary embodiment may request the terminal apparatus 100 to collect contexts regarding the extended service, and provide the extended service based on the contexts received from the terminal apparatus 100, in response to the request.

Hereinafter, a method for providing contexts regarding an extended service to the server 200 from the terminal apparatus 100 will be described in detail.

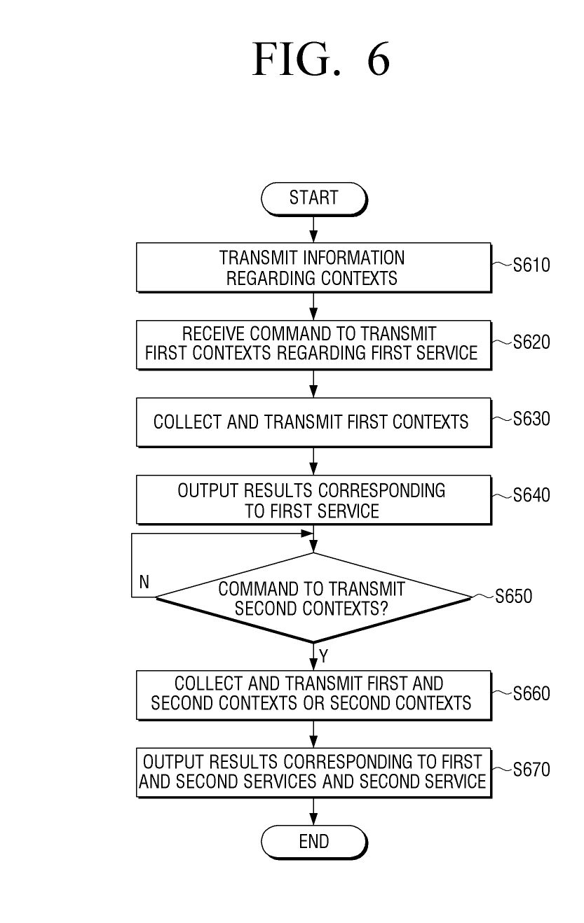

FIG. 6 is a flowchart which illustrates a method for providing to a server contexts regarding an extended service, from a terminal apparatus according to an exemplary embodiment.

As illustrated in FIG. 6, when communication with the server 200 is initiated for the first time, the terminal apparatus 100 transmits information regarding pre-stored contexts to the server 200 (S610). Herein, the information regarding contexts is metadata which defines contexts collectable from the terminal apparatus 100 in association with the service provided by the server 200, and may be defined as a schema such as XMI or RDF and stored in the storage 140. Depending on an exemplary embodiment, the contexts collectable from the terminal apparatus 100 may include at least one of information regarding a channel of a broadcast program which a user is currently watching, information related to viewing history regarding a broadcast program which has been watched by a user, information regarding an application installed in the terminal apparatus 100 or information regarding execution history of an installed application, location information of the terminal apparatus 100, and user information.

After transmitting information regarding collectable contexts to the server 200, the terminal apparatus 100 outputs results which correspond to the first service provided by the server based on pre-collected first contexts. Specifically, in response to a command to transmit the first contexts regarding the first service being received from the server 200, the terminal apparatus 100 collects the first contexts and transmits the collected first contexts to the server 200 according to the received transmission command (S620, S630). Accordingly, the server 200 provides the first service to the terminal apparatus 100 based on the received first contexts, and the terminal apparatus 100 outputs results which correspond to the first service provided by the server 200 (S640).

Subsequently, when a command to transmit contexts regarding a changed service is received from the server 200, the terminal apparatus 100 collects contexts corresponding to the received transmission command and transmits the collected contexts to the server 200. Specifically, an event to add the second service or change the service may occur while the server 200 is providing the first service. In this case, the server 200 determines whether it is possible to collect the second contexts regarding the second service from the terminal apparatus 100 based on information regarding pre-stored contexts. If it is determined that it is possible to collect the second contexts, the server 200 requests the terminal apparatus 100 transmit the second contexts. Accordingly, the terminal apparatus 100 determines whether a command to transmit the second contexts regarding the second service which is added or changed is received from the server 200 (S650). If it is determined that a command to transmit the second contexts is received, the terminal apparatus 100 collects the second contexts and transmits the collected second contexts to the server 200 according to the received transmission command (S660). Accordingly, the server 200 may provide the second service based on the received second contexts, and the terminal apparatus 100 may output results which correspond to the second service provided by the server 200, in at least one of a voice and an image (S670).

In an exemplary embodiment, in response to the occurrence of an event to add the second contents in the server 200, the terminal apparatus 100 may receive a command to further transmit the second contexts from the server 200. In this case, the terminal apparatus 100 may collect the first contexts regarding the first service and the second contexts regarding the second service and transmit the collected first and second contexts to the server 200. Accordingly, the server 200 may provide the first and second services based on the received first and second contexts, and the terminal apparatus 100 may output results which correspond to the first and second services provided by the server 200 through at least one of a voice and an image.

In another exemplary embodiment, in response to an event to change to the second service occurs in the server 200, the terminal apparatus 100 may receive a command to change the contexts and transmit the second contexts from the server 200. In this case, the terminal apparatus 100 stops collecting the first contexts regarding the first service, collects the second contexts regarding the second service, and transmits the collected second contexts to the server 200. Accordingly, the server 200 may provide the second service based on the second contexts received from the terminal apparatus 100, and the terminal apparatus 100 may output results which correspond to the second service provided by the server 200, through at least one of a voice and an image.

In the above description, various exemplary embodiments have been explained.

According to various exemplary embodiments, when a server providing a service based on contexts received from a terminal apparatus provides an extended service, the server may request the corresponding terminal apparatus transmit contexts regarding the extended service dynamically. Accordingly, terminal apparatus may set a function of collecting contexts regarding the extended service or may resolve problems associated with using the extended service provided by the server.

The foregoing exemplary embodiments and advantages are merely exemplary and are not to be construed as limiting the inventive concept. The present teaching can be readily applied to other types of apparatuses. Also, the description is intended to be illustrative, and not to limit the scope of the claims, and many alternatives, modifications, and variations will be apparent to those skilled in the art.

What is claimed is:

1. A server, comprising:
a communicator configured to communicate with a terminal apparatus;
a storage configured to store information regarding contexts collected from the terminal apparatus;
a determinator configured to, in response to an occurrence of an event to change a service provided by the server, determine whether contexts regarding the changed service are collectable from the terminal apparatus based on the information regarding contexts; and
a controller configured to, in response to the determinator determining that the contexts regarding the changed service are collectable, request the terminal apparatus transmit the contexts regarding the changed service and provide the changed service based on the contexts received in response to the request.

2. The server as claimed in claim 1, wherein in response an occurrence of an event to add a second service while a first service is provided based on first contexts received from the terminal apparatus, the determinator determines whether contexts regarding the added second service are collectable,
wherein in response to the determinator determining that the contexts regarding the added second service are collectable, the controller requests the terminal apparatus transmit second contexts regarding the added second service, and provides the added second service based on the second contexts received in response to the request.

3. The server as claimed in claim 1, wherein in response to the occurrence of an event to change to a third service while the first service is provided based on the first contexts received from the terminal apparatus, the determinator determines whether contexts regarding the changed third service are collectable,
wherein in response to the determinator determining that the contexts regarding the changed third service are collectable, the controller requests the terminal apparatus to transmit third contexts regarding the changed third service, and provides the changed third service based on the third contexts received in response to the request.

4. The server as claimed in claim 1, wherein in response to the determinator determining that the contexts regarding the changed service are not collectable, the controller provides the changed service based on at least one of predetermined conditions and contexts collected from other terminal apparatuses.

5. The server as claimed in claim 1, wherein the contexts include at least one of channel information related to a program which is currently watched, information related to viewing history, application information, location information of the terminal apparatus, and user information.

6. The server as claimed in claim 1, wherein the terminal apparatus is at least one of a user terminal apparatus and a content providing server which is interlocked with the user terminal apparatus.

7. A terminal apparatus comprising:
an output unit;
a communicator configured to transmit information regarding contexts collectable from the terminal apparatus to a server and configured to receive from the server a command to transmit contexts regarding the changed service according to an event to change a service provided by the server; and
a controller configured to transmit contexts collected in response to the received transmission command to the server, and configured to control the output unit to output results corresponding to a service provided by the server based on the transmitted contexts.

8. The apparatus as claimed in claim 7, wherein in response to receiving from the server a command to transmit second contexts regarding the second service while the output unit outputs results corresponding to a first service based on pre-collected first contexts, the controller collects the second contexts and transmits to the server the collected second contexts according to the received transmission command.

9. The apparatus as claimed in claim 7, wherein the contexts include at least one of channel information related to a program which is currently watched, information related to viewing history, application information, location information of the terminal apparatus and user information.

10. A service transit apparatus comprising:
a communicator configured to communicate with a terminal apparatus;
a storage configured to store information regarding contexts collectable from the terminal apparatus;
a determinator configured to, in response to an occurrence of an event to change a service provided by a service providing server, determine whether contexts regarding the changed service are collectable form the terminal apparatus based on information regarding the contexts; and
a controller configured to, in response to the determinator determining that the contexts regarding the changed service are collectable, control to request the terminal apparatus to transmit the contexts regarding the changed service and transmit the contexts received in response to the request to the service providing server.

11. A method of controlling a server, the method comprising:
storing information regarding contexts collectable from a terminal apparatus;
in response to the occurrence of an event to change a service provided by the server, determining whether contexts regarding the changed service are collectable from the terminal apparatus based on information regarding the contexts; and
in response to determining that the contexts regarding the changed service are collectable, requesting the terminal apparatus transmit the contexts regarding the changed service, and providing the changed service to the terminal apparatus based on the contexts received from the terminal apparatus in response to the request.

12. The method as claimed in claim 11, wherein the determining comprises, in response to an occurrence of an event to add a second service, determining whether contexts regarding the added second service are collectable while a first service is provided, based on first contexts received from the terminal apparatus,
wherein the providing the changed service comprises, in response to determining that the contexts regarding the added second service are collectable, requesting the terminal apparatus to transmit second contexts regarding the added second service, and providing the added second service based on the second contexts received in response to the request.

13. The method as claimed in claim 11, wherein the determining comprises, in response to an occurrence of an event to change a service to a third service while a first service is provided based on first contexts received from the terminal apparatus, determining whether contexts regarding the changed third service are collectable,
wherein the providing the changed service comprises, in response to determining that contexts regarding the changed third service are collectable, requesting the terminal apparatus to transmit third contexts regarding the changed third service, and providing the changed third service based on the third contexts received in response to the request.

14. The method as claimed in claim 11, wherein the providing the changed service comprises, in response to determining that the contexts regarding the changed service are not collectable, providing the changed service based on at least one of predetermined conditions and contexts collected from other terminal apparatuses.

15. The method as claimed in claim 11, wherein the contexts include at least one of channel information of a program which is currently watched, information related to viewing history, application information, location information of the terminal apparatus and user information.

16. The method as claimed in claim 11, wherein the terminal apparatus is at least one of a user terminal apparatus and a content providing server which is interlocked with the user terminal apparatus.

17. A method for controlling a terminal apparatus, the method comprising:
transmitting information regarding contexts collectable from the terminal apparatus to a server;
receiving a command to transmit contexts regarding the changed service from the server according to an event to change a service provided by the server;
collecting contexts corresponding to the received transmission command and transmitting the collected contexts to the server; and
outputting results corresponding to a service provided by the server based on the transmitted contexts.

18. The method as claimed in claim 17, further comprising:
after the transmitting the information regarding the collectable contexts to the server, outputting results corresponding to a first service provided by the server based on pre-collected first contexts,
wherein the transmitting the collected contexts to the server comprises, in response to receiving a command to transmit second contexts regarding the second service from the server, collecting the second contexts and transmitting to the server the collected second contexts according to the received transmission command.

19. The method as claimed in claim 17, wherein the contexts include at least one of channel information of a program which is currently watched, information related to viewing history, application information, location information of the terminal apparatus and user information.

20. A server, comprising:
a determinator configured to determine whether contexts regarding a changed service are collectable from a terminal apparatus based on received information regarding contexts; and
a controller configured to request the terminal apparatus transmit the contexts regarding the changed service and provide the changed service based on the contexts received in response to the request, in response to the determinator determining that the contexts regarding the changed service are collectable.
